(19) United States
(12) Patent Application Publication
(10) Pub. No.: US 2010/0175306 A1
(43) Pub. Date: Jul. 15, 2010

(54) Fishing Weight Sinker

(76) Inventor: Phommarack Louy Pravong, Bedford, TX (US)

Correspondence Address: Phommarack Louy Pravong, 3829 Lacebark Ln, Bedford, TX, 76021, US

(21) Appl. No.: 12/353,531

(22) Filed: Jan. 14, 2009

(51) Int. Cl. A01K 95/00

(52) U.S. Cl. 43/43.1

(57) ABSTRACT

A sinker apparatus may include a central core, a sphere having a hollow central portion to cooperate with the central core, a rigid rod which extends from the central core, a swivel to connect with the rigid rod and adapted to be connected to fishing line. The rigid rod may be connected to a swivel, and the swivel may be connected to a fishing line. The sphere may include an outer surface with dimples.

### FIELD OF THE INVENTION

The present invention relates generally to a fishing sinker and more specifically to a fishing sinker with a configuration which resembles a golf ball.

### BACKGROUND OF THE INVENTION

A variety of fishing sinkers or weights currently exist in the art. These sinkers function primarily to provide weight to a fishing line for the purpose of causing the fishing line and the attached bait or lure to sink below the water surface. A variety of sinker configurations exist. Some sinkers are designed for attachment to the fishing line at a fixed position. Others, commonly referred to as slip sinkers, are allowed to slip or slide along the fishing line within certain limits. For the most part, these sinkers are constructed of a heavy metal or other material to provide sinker with the necessary weight. Lead or lead alloys are materials commonly used in the manufacture of currently available fishing sinkers. Some, however, such as the sinkers of the LaForce U.S. Pat. No. 3,852,906, the Wohead U.S. Pat. No. 4,693,030, the Foster U.S. Pat. No. 3,012,359 and the Miller U.S. Pat. No. 5,303,499 disclose sinkers with buoyant capability.

Although the current fishing sinkers adequately provide the function of causing the fishing line and attached bait or lure to sink below the water surface as desired, the sinkers of the prior art comprise multiple parts and/or often become snagged or hung up, particularly in fishing areas with rocks, brush, weed beds or stump fields. As a result, many of these snag infested fishing waters are considered “off limits” with certain conventional sinkers.

With the currently increasing population of golfers, the requirements on golf balls have been diversified and personalized. In order to satisfy the needs of both golfers and fishermen, it would be desirable to have a device that could be interesting to both golfers and fishermen. For the fishermen/golfer, this device can be hit with an object such as a golf driver, bat or similar device.

### SUMMARY

A sinker apparatus may include a central core, a sphere having a hollow central portion to cooperate with the central core, a rigid rod which extends from the central core, a swivel to connect with the rigid rod and adapted to be connected to fishing line.

The rigid rod may be connected to a swivel, and the swivel may be connected to a fishing line.

The sphere may include an outer surface with dimples.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the fishing sinker with fishing line of the present invention;

FIG. 2 illustrates a perspective view of the fishing sinker of the present invention;

FIG. 3 illustrates a cutaway view of the fishing sinker of the present invention;

### DETAILED DESCRIPTION

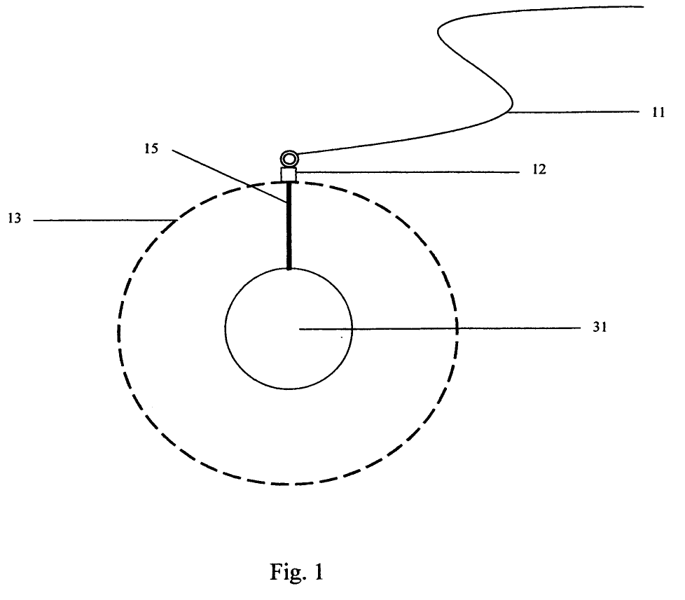

FIG. 1 illustrates a side cross-sectional view of the fishing weight sinker 13 which may be considered as a golf ball like apparatus. FIG. 1 additionally illustrates a swivel 12 which may be fastened to an end of a rigid rod 15 which may be formed from metal such as steel, copper, iron or other such material and the rigid rod 15 may extend to the core 31 of the fishing weight sinker 13. The swivel 12 may rotate on the end of the rigid rod 15 in order to avoid the fishing weight sinker 13 from twisting the fishing line 11 as the fishing weight sinker 13 travels through the water or air.

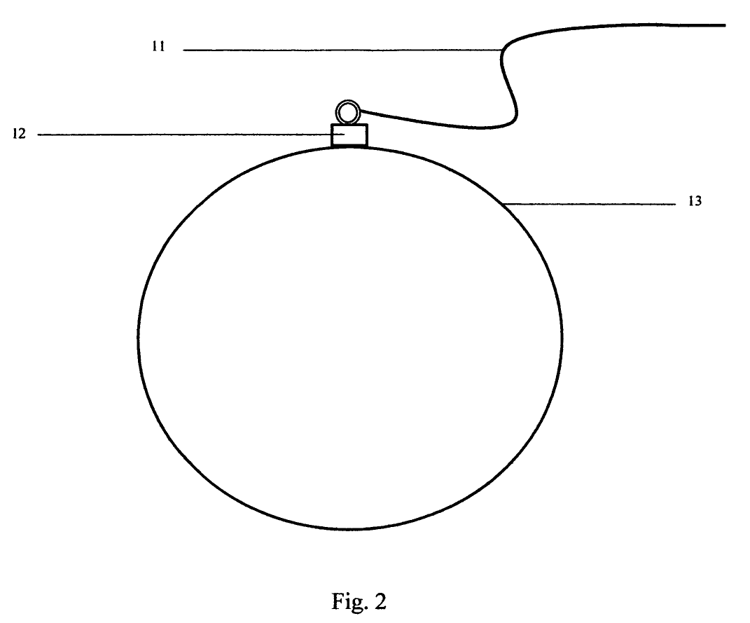

FIG. 2 illustrates a perspective view of the fishing sinker 13 which may be a sphere or other appropriate shape and may include dimples to provide the fishing sinker 13 with a golf ball like appearance.

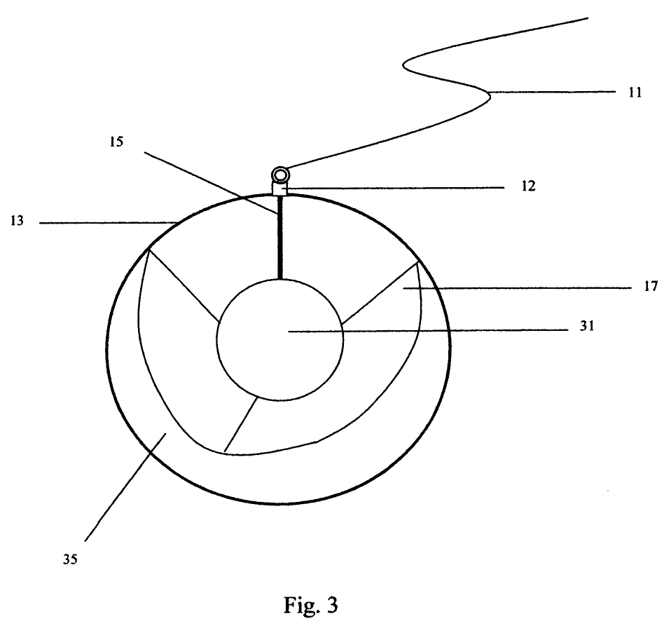

FIG. 3 illustrates a cross-sectional view showing the fishing weight sinker 13 which may include a rigid central core 31 which may be formed from lead, steel or other appropriate material in order to provide weight for the fishing weight sinker 13. The rigid central core 31 may be substantially surrounded by a flexible outer sphere 17 having a hollow center in order to cooperate with the rigid central core 31. FIG. 3 illustrates that the rigid rod 15 extends from the rigid central core 31 to the swivel 12. FIG. 3 illustrates that the rigid rod 15 extends a sufficient distance in order that the swivel 12 extends beyond the outer surface 35 of the flexible outer sphere 17 while FIG. 1 extends beyond the outer surface 35. The outer surface 35 may be a flexible surface and may include dimples in order to achieve a golf like appearance.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A sinker apparatus, comprising:
a central core;
a sphere having a hollow central portion to cooperate with the central core;
a rigid rod which extends from the central core;
a swivel to connect with the rigid rod and adapted to be connected to fishing line.

2. A sinker apparatus as in claim 1, wherein the rigid rod is connected to a swivel.

3. A sinker apparatus as in claim 2, wherein the swivel is adapted to be connected to a fishing line.

4. A sinker apparatus as in claim 1, wherein the sphere includes an outer surface with dimples.
